(19) United States
(12) Patent Application Publication
(10) Pub. No.: US 2026/0291105 A1
(43) Pub. Date: Sep. 24, 2026

(54) TERMINAL

(71) Applicant: I-PEX Inc., Kyoto-shi, Kyoto (JP)

(72) Inventor: Seimu KAMADA, Machida-shi (JP)

(21) Appl. No.: 19/474,354

(22) PCT Filed: Apr. 3, 2024
(86) PCT No.: PCT/JP2024/013835

§ 371 Date: Oct. 10, 2025

(30) Foreign Application Priority Data
Apr. 13, 2023 (JP) 2023-065964

(51) Int. Cl. H01R 13/11; H01R 12/71

(52) U.S. Cl. CPC H01R 13/113; H01R 12/712

(57) ABSTRACT

A receptacle terminal (1A) is formed of a conductive material and configured to mate with a plug terminal. The receptacle terminal (1A) includes a frame portion (30) that has an insertion opening (30a) through which a plug contact portion of the plug terminal is inserted and removed, and a first contact piece (31) and a second contact piece (32) that each have one end connected to the frame portion (30), extend from the one end in an insertion direction of the plug contact portion included in an insertion and removal direction of the plug contact portion with respect to the insertion opening (30a), and come in contact with the plug contact portion at a contact between the one end and the other end. The frame portion (30) is formed of a continuous member with no cuts along an edge of the insertion opening (30a).

### TECHNICAL FIELD

The present disclosure relates to a terminal.

### BACKGROUND ART

Patent Literature 1 discloses an relay terminal formed by performing bending processing on a single rectangular plate material. The relay terminal includes a box portion that has openings at both longitudinal ends, and a pair of contact portions that are bent from both ends of the box portion toward the inside of the box portion and are disposed to face each other. The relay terminal mates with and relays two tab terminals (plug terminals) by the pair of contact portions holding the tab terminals inserted in both ends of the box portion.

### CITATION LIST

### Patent Literature

Patent Literature 1: Examined Japanese Utility Model Application Publication No. H6-16430.

### SUMMARY OF INVENTION

### Technical Problem

The box portion of the relay terminal disclosed in Patent Literature 1 is configured by bending the conductive rectangular plate material such that two outer edges thereof extending in the longitudinal direction face each other, and has a simple structure in which the outer edges form a seam (a cut) therebetween (see FIG. 1(A)). Therefore, for example, when a plug terminal is inserted, the box portion is likely to deform due to a force received from the plug terminal (a mating terminal). When the box portion is deformed, a large amount of force might be required to insert the mating terminal (or insertion might be difficult), or the mating terminal might be easily removed.

The present disclosure is made in view of the above-described circumstances, and an objective of the present disclosure is to provide a terminal that allows insertion of a mating terminal without using a large amount of force while preventing the inserted mating terminal from being removed.

### Solution to Problem

In order to achieve the above-described objective, a terminal according to a first aspect of the present disclosure is a terminal formed of a conductive material and configured to mate with a mating terminal, and the terminal includes:
a frame portion having an insertion opening through which a mating contact piece of the mating terminal is inserted and removed; and
contact pieces each having one end connected to the frame portion and extending from the one end in an insertion direction of the mating contact piece included in an insertion and removal direction of the mating contact piece with respect to the insertion opening, each of the contact pieces being configured to come into contact with the mating contact piece at a contact between the one end and the other end, wherein
the frame portion is formed of a continuous member with no cut along an edge of the insertion opening.

The contact pieces may be a pair of elastic members to hold the mating contact piece between the contacts.

The pair of elastic members may have the contacts each protruding in a direction approaching the other.

Each of the contact pieces may have a distance from the one end to the contact longer than a distance from the contact to the other end.

The frame portion may be formed of a single plate material, and the insertion opening may be a through hole passing through the plate material in a thickness direction thereof.

The one end may be formed at the edge of the insertion opening.

The one end may be formed at an outer edge of the frame portion.

The terminal may further include:
a substrate connection portion connected to a substrate; and
a pair of elastic portions to connect the substrate connection portion and the frame portion, wherein
each elastic portion of the pair of elastic portions includes
   a first spring portion having one end connected to the frame portion, the first spring portion extending in a first direction intersecting the insertion and removal direction of the mating terminal, and
   a second spring portion having one end connected to the other end of the first spring portion and the other end connected to the substrate connection portion, the second spring portion extending in a second direction intersecting the insertion and removal direction and the first direction.

### Advantageous Effects of Invention

The terminal according to the present disclosure allows insertion of the mating terminal without using a large amount of force while preventing the inserted mating terminal from being removed.

### BRIEF DESCRIPTION OF DRAWINGS

FIG. 1 is a first perspective view illustrating the appearance of a receptacle terminal according to Embodiment 1 of the present disclosure;

FIG. 2 is a plan view of the receptacle terminal in FIG. 1 before bending processing is performed;

FIG. 3 is a second perspective view illustrating the appearance of the receptacle terminal according to Embodiment 1 of the present disclosure;

FIG. 4 is a side view of the receptacle terminal in FIG. 1;

FIG. 5 is a schematic view of a simplified structure of the receptacle terminal in FIG. 1;

FIG. 6 is a perspective view illustrating the appearance of a plug terminal according to Embodiment 1 of the present disclosure;

FIG. 7 is a perspective view illustrating a configuration in which the receptacle terminal in FIG. 1 mates with the plug terminal in FIG. 6;

FIG. 8 is a cross-sectional view illustrating the configuration in which the receptacle terminal in FIG. 1 mates with the plug terminal in FIG. 6;

FIG. 9A is a schematic view illustrating a force generated when the plug terminal is inserted;

FIG. 9B is a schematic view illustrating a force generated when the plug terminal is removed;

FIG. 10 is a perspective view illustrating the appearance of a receptacle terminal according to Embodiment 2 of the present disclosure;

FIG. 11 is a plan view of the receptacle terminal in FIG. 10 before the bending processing is performed;

FIG. 12 is a cross-sectional view of the receptacle terminal in FIG. 10;

FIG. 13 is a perspective view illustrating the appearance of a receptacle terminal according to Embodiment 3 of the present disclosure; and

FIG. 14 is a perspective view illustrating a configuration in which the receptacle terminal in FIG. 13 mates with the plug terminal in FIG. 6.

### DESCRIPTION OF EMBODIMENTS

Hereinafter, embodiments of the present disclosure are described in detail with reference to the drawings. In the drawings, the same or equivalent parts are assigned the same reference signs. In the present embodiments, description is made as appropriate using a three-axis Cartesian coordinate system defined by X, Y, and Z axes illustrated in the drawings.

### Embodiment 1

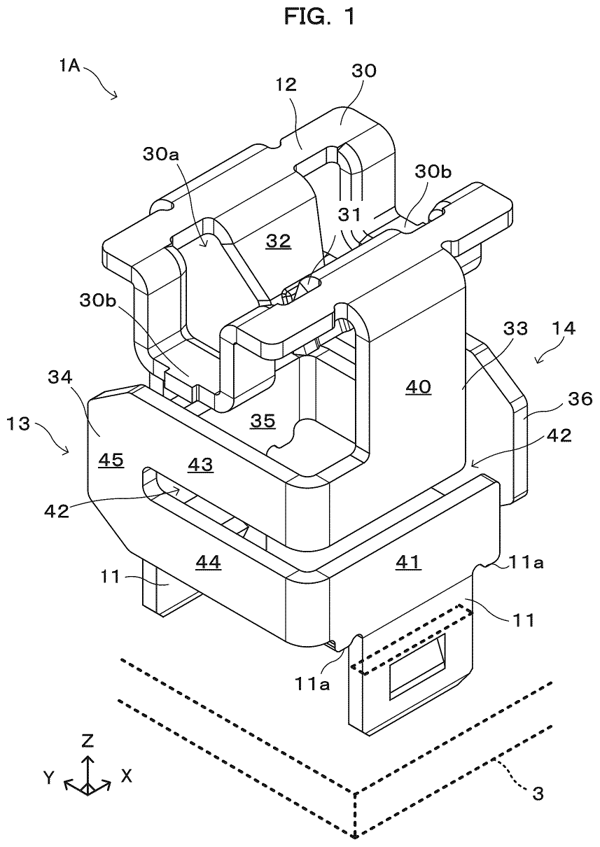

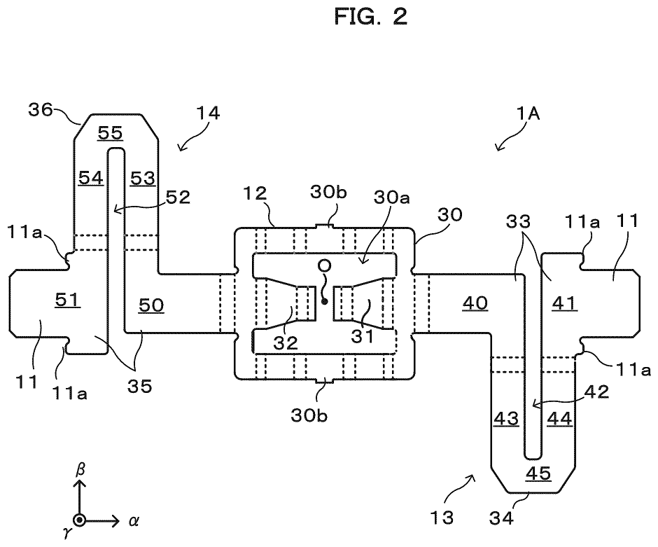

First, Embodiment 1 of the present disclosure is described. The present embodiment describes a receptacle terminal 1A illustrated in FIG. 1 and a plug terminal 2 illustrated in FIG. 2. The receptacle terminal 1A and the plug terminal 2 mate with each other.

### Receptacle Terminal

First, the receptacle terminal 1A is described. As illustrated in FIG. 1, the receptacle terminal 1A is mounted on a first substrate 3. In FIG. 1, the first substrate 3 is illustrated by a dotted line. In the present embodiment, X and Y axes are defined as coordinate axes along a main surface of the first substrate 3, and a Z axis is defined as a coordinate axis along a normal direction of the main surface of the first substrate 3.

The receptacle terminal 1A is formed of a conductive and elastic material such as metal. As this material, for example, a copper alloy is used. Examples of the copper alloy include beryllium copper, phosphor bronze, and titanium copper.

The receptacle terminal 1A is formed by, for example, performing punching processing and bending processing on a metal plate. Specifically, the receptacle terminal 1A is formed by performing the punching processing on an elastic metal plate to be processed into a shape illustrated in FIG. 2. In FIG. 2, coordinate axes along an in-plane direction of the metal plate are defined as α and β axes, and a coordinate axis along a thickness direction of the metal plate is defined as a γ axis. As illustrated in FIG. 2, the punching processing is performed on the metal plate to be processed into a point-symmetric shape with respect to a central point O. After the punching processing, the metal plate is bent along broken lines by the bending processing to be processed into a shape illustrated in FIG. 1. The metal plate has a plate thickness of, for example, about 0.5 mm, which is not limited thereto.

Returning to FIG. 1, the receptacle terminal 1A includes receptacle substrate connection portions 11, a receptacle contact portion 12, a first receptacle elastic portion 13, and a second receptacle elastic portion 14.

### Receptacle Substrate Connection Portions

The receptacle substrate connection portions 11 are connected to the first substrate 3. The receptacle terminal 1A includes a pair of the receptacle substrate connection portions 11. The first substrate 3 has rectangular through holes, and the receptacle substrate connection portions 11 are inserted into the through holes and soldered. In this way, the receptacle terminal 1A is mounted on the main surface of the first substrate 3. The receptacle substrate connection portions 11 have retaining projections formed by stamping, and these retaining projections prevent the receptacle substrate connection portions 11 from being removed from the through holes. Each of the receptacle substrate connection portions 11 includes receptacle positioning portions 11a to prevent the receptacle terminal 1A from being mounted obliquely to the first substrate 3. On the main surface of the first substrate 3, electronic components are mounted and an electric circuit including these electronic components is constructed. An electrode is connected to the electric circuit, and the receptacle substrate connection portions 11 inserted in the through holes of the first substrate 3 are connected to the electrode.

### Receptacle Contact Portion

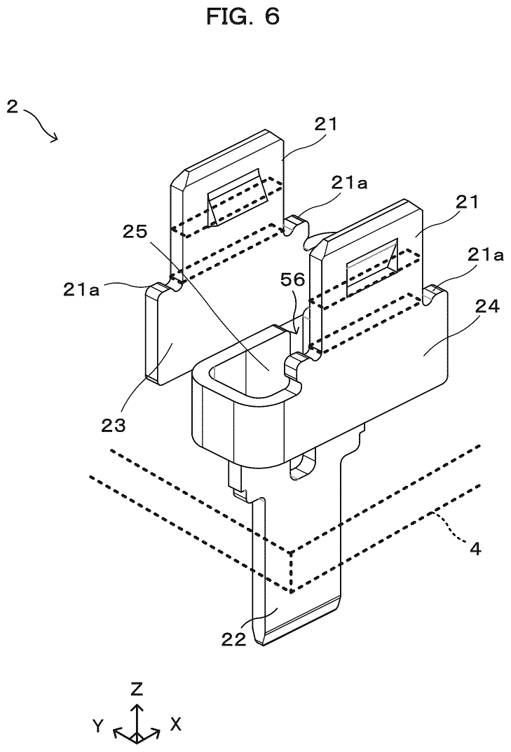

As illustrated in FIG. 1, the receptacle contact portion 12 is a recessed contact. The receptacle contact portion 12 comes in contact with a protruding plug contact portion 22 of the plug terminal 2 (see FIG. 6) inserted in an insertion and removal direction.

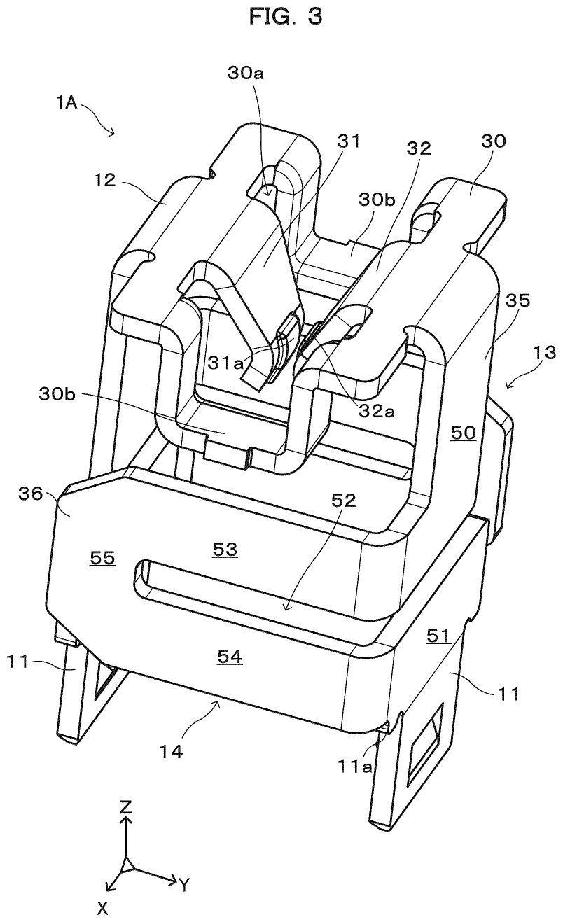

As illustrated in FIGS. 1 and 3, the receptacle contact portion 12 includes a frame portion 30, a first contact piece 31, and a second contact piece 32. The frame portion 30 is formed of a single plate material as illustrated in FIG. 2. In the present embodiment, the frame portion 30 before the bending processing is performed has a rectangular outer shape. The frame portion 30 has an insertion opening 30a through which the plug contact portion 22 of the plug terminal 2 (see FIG. 6) is inserted and removed. The insertion opening 30a is a through hole passing through the plate material in a thickness direction thereof. The insertion opening 30a is formed at the center of the frame portion 30, and has a rectangular outer shape. The frame portion 30 is formed of a continuous member with no cuts along an edge of the insertion opening 30a. Therefore, even when a force is applied from the plug terminal 2 during insertion or removal thereof, the deformation amount of the frame portion 30 is negligibly small.

As illustrated in FIGS. 1 and 3, the first contact piece 31 and the second contact piece 32 are a pair of elastic members disposed facing each other in a Y-axis direction. Each of the first contact piece 31 and the second contact piece 32 has one end connected to the frame portion 30. In the present embodiment, the first contact piece 31 and the second contact piece 32 are connected to inner edges of the frame portion 30, that is, the edge of the insertion opening 30a.

The first contact piece 31 and the second contact piece 32 are cantilevers extending in a −Z direction that is an insertion direction of the plug contact portion 22 included in the insertion and removal direction of the plug contact portion 22 with respect to the insertion opening 30a. The first contact piece 31 and the second contact piece 32 hold the plug contact portion 22 of the plug terminal 2 (see FIG. 6) inserted therebetween.

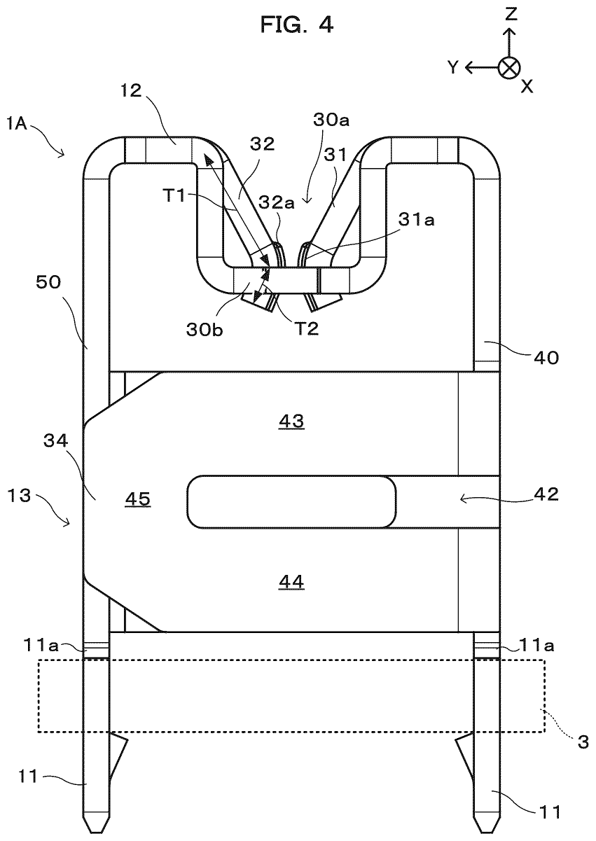

As illustrated in FIG. 3, the first contact piece 31 includes a stamped contact 31a between the one end, which is connected to the frame portion 30, and the other end. The second contact piece 32 includes a stamped contact 32a between the one end, which is connected to the frame portion 30, and the other end. The first contact piece 31 comes in contact with the plug contact portion 22 at the stamped contact 31a, and the second contact piece 32 comes in contact with the plug contact portion 22 at the stamped contact 32a. As illustrated in FIG. 4, in the first contact piece 31 and the second contact piece 32, each of the stamped contacts 31a and 32a protrudes in a direction approaching the other. The first contact piece 31 and the second contact piece 32 hold the plug contact portion 22 between the stamped contacts 31a and 32a. Thus, even when a position deviation occurs between the first contact piece 31 or the second contact piece 32 and the plug contact portion 22 of the plug terminal 2, the first contact piece 31 or the second contact piece 32 easily follows the plug contact portion 22.

As illustrated in FIGS. 1 and 3, the receptacle contact portion 12 includes regulation portions 30b that regulate an increase in a gap between the first contact piece 31 and the second contact piece 32. As illustrated in FIG. 2, after the punching processing, the receptacle contact portion 12 includes the frame portion 30 at the center, and the central point O is located at the center of the frame portion 30. The receptacle contact portion 12 has a point-symmetric shape with the central point O at the center. In the receptacle contact portion 12, when viewed from the central point O, a band-shaped member protrudes from the inner edge of the frame portion 30 closer to a +α direction to a position not exceeding the central point O toward a −α direction. This band-shaped member is bent at a plurality of portions including an end portion along bent lines illustrated by broken lines parallel to a β-axis direction to form the first contact piece 31 illustrated in FIGS. 1 and 3. In addition, when viewed from the central point O, a band-shaped member protrudes from the inner edge of the frame portion 30 closer to the −α direction to a position not exceeding the central point O toward the +α direction. This band-shaped member is bent at a plurality of portions including an end portion along bent lines illustrated by broken lines parallel to the β-axis direction to form the second contact piece 32 illustrated in FIGS. 1 and 3. As illustrated in FIG. 4, in each of the first contact piece 31 and the second contact piece 32, a distance T1 from the one end of the frame portion 30 to the stamped contact 31a or 32a is set to be longer than a distance T2 from the stamped contact 31a or 32a to the other end (T1>T2). This is because, on the metal plate, the first contact piece 31 and the second contact piece 32 need to be formed within a frame of the frame portion 30, as illustrated in FIG. 3.

As illustrated in FIG. 1, a pair of the regulation portions 30b is provided in +X and −X directions when viewed from the first contact piece 31 and the second contact piece 32, respectively. The regulation portions 30b are formed by being bent along bent lines illustrated by broken lines parallel to the β-axis direction illustrated in FIG. 2.

As illustrated in FIGS. 1, 3, and 4, the regulation portions 30b are bent in a recessed shape in a direction approaching the receptacle substrate connection portions 11 with respect to the insertion and removal direction, that is, in the −Z direction. This is intended to cause the first contact piece 31 and the second contact piece 32 to approach each other when the receptacle contact portion 12 is formed by the bending processing on the metal plate (see FIG. 2). The regulation portions 30b bent in a recessed shape in the −Z direction can, when the plug contact portion 22 of the plug terminal 2 (see FIG. 6) is inserted between the first contact piece 31 and the second contact piece 32, prevent the regulation portions 30b from interfering with the plug contact portion 22.

As illustrated in FIGS. 1, 2, and 3, the first receptacle elastic portion 13 and the second receptacle elastic portion 14 are connected to the frame portion 30 of the receptacle contact portion 12. The frame portion 30 is connected to the first receptacle elastic portion 13 at an outer edge closer to the −Y direction (the +α direction) included in two outer edges along the X-axis direction, and is connected to the second receptacle elastic portion 14 at an outer edge closer to the +Y direction (the −α direction) included in the above-described two outer edges.

### First Receptacle Elastic Portion

The first receptacle elastic portion 13 connects one receptacle substrate connection portion 11 of the pair of receptacle substrate connection portions 11 to the receptacle contact portion 12. As illustrated in FIG. 2, before the bending processing is performed, the first receptacle elastic portion 13 is a band-shaped member bent and extending in the α-axis and the β-axis directions, has one end closer to the +α and +β directions that is connected to the receptacle substrate connection portion 11, and has the other end closer to the −αdirection that is connected to the receptacle contact portion 12. The first receptacle elastic portion 13 includes, between an end portion connected to the receptacle contact portion 12 and an end portion connected to the receptacle substrate connection portion 11, a receptacle slit 42 that extends in the β-axis direction. The first receptacle elastic portion 13 has a bent shape due to the receptacle slit 42.

The first receptacle elastic portion 13 includes a first receptacle spring portion 33 and a second receptacle spring portion 34. The first receptacle elastic portion 13 is formed in a shape illustrated in FIG. 1 by being bent at 90 degrees along a bent line illustrated by a broken line parallel to the β axis (see FIG. 2) with respect to the receptacle contact portion 12, and being bent at 90 degrees along a bent line illustrated by a broken line parallel to the a axis (see FIG. 2) at a boundary between the first receptacle spring portion 33 and the second receptacle spring portion 34.

As illustrated in FIG. 1, the first receptacle spring portion 33 includes a first receptacle contact connection portion 40 that is connected to the receptacle contact portion 12. The first receptacle contact connection portion 40 is a member having an L-shape (a mirror image of the letter L) when viewed in the Y-axis direction, has one end (an end portion closer to a +Z direction) connected to the receptacle contact portion 12, extends from the connected portion in the −Z direction, and is bent in the −X direction.

The first receptacle spring portion 33 and the second receptacle spring portion 34 have the receptacle slit 42 that extends in a direction intersecting the insertion and removal direction. As illustrated in FIG. 1, the first receptacle spring portion 33 is divided by the receptacle slit 42 into the above-described first receptacle contact connection portion 40 and a third extension portion 41. The second receptacle spring portion 34 includes a first extension portion 43, a second extension portion 44, and a first return portion 45 due to the receptacle slit 42.

As illustrated in FIG. 1, the first extension portion 43 extends in the Y-axis direction that is a direction intersecting the insertion and removal direction. The first extension portion 43 has one end (an end portion closer to the −Y direction) connected to an end portion of the first receptacle contact connection portion 40 closer to the −X direction. The second extension portion 44 is disposed closer to the receptacle substrate connection portion 11 than the first extension portion 43. The second extension portion 44 extends in parallel with the first extension portion 43, that is, in the Y-axis direction. The first return portion 45 connects, in the insertion and removal direction, that is, in the Z-axis direction, the other end (an end portion closer to the +Y direction) of the first extension portion 43 to one end (an end portion closer to the +Y direction) of the second extension portion 44 that faces the other end of the first extension portion 43.

Furthermore, in the first receptacle spring portion 33, the third extension portion 41 is located closer to the receptacle substrate connection portion 11 than the first receptacle contact connection portion 40, and extends in the X-axis direction that intersects the insertion and removal direction. The third extension portion 41 has one end (an end portion closer to the −X direction) connected to the other end (an end portion closer to the −Y direction) of the second extension portion 44. The third extension portion 41 is connected to the receptacle substrate connection portion 11.

As described above, the first receptacle elastic portion 13 is configured by sequentially connecting, from the receptacle contact portion 12, the first receptacle contact connection portion 40, the first extension portion 43, the first return portion 45, the second extension portion 44, and the third extension portion 41, and is ultimately connected to the receptacle substrate connection portion 11.

### Second Receptacle Elastic Portion

The second receptacle elastic portion 14 connects the other receptacle substrate connection portion 11 of the pair of receptacle substrate connection portions 11, which is not connected to the first receptacle elastic portion 13, to the receptacle contact portion 12. As illustrated in FIG. 2, before the bending processing is performed, the second receptacle elastic portion 14 is a band-shaped member bent and extending in the α-axis and β-axis directions, has one end closer to the −α and −β directions that is connected to the receptacle substrate connection portion 11, and has the other end closer to the +α direction that is connected to the receptacle contact portion 12. The second receptacle elastic portion 14 includes, between an end portion connected to the receptacle contact portion 12 and an end portion connected to the receptacle substrate connection portion 11, a receptacle slit 52 that extends in the β-axis direction. The second receptacle elastic portion 14 has a bent shape due to the receptacle slit 52.

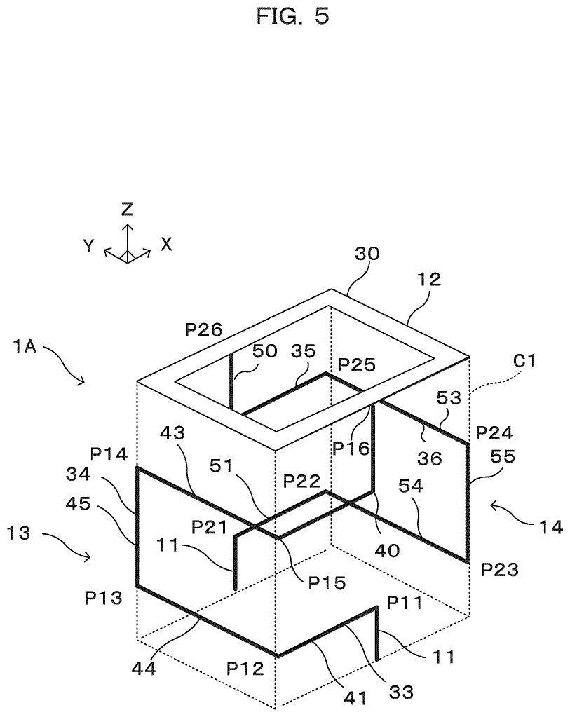

The second receptacle elastic portion 14 includes a third receptacle spring portion 35 and a fourth receptacle spring portion 36. The second receptacle elastic portion 14 is formed in a shape illustrated in FIG. 3 by being bent at 90 degrees along a bent line illustrated by a broken line parallel to the β axis (see FIG. 2) with respect to the receptacle contact portion 12, and being bent at 90 degrees along a bent line illustrated by a broken line parallel to the a axis (see FIG. 2) at a boundary between the third receptacle spring portion 35 and the fourth receptacle spring portion 36. As illustrated in FIGS. 1 and 3, the first receptacle elastic portion 13 and the second receptacle elastic portion 14 are formed by being bent to form part of a side surface of a rectangular parallelepiped C1 (see FIG. 5) as a whole.

As illustrated in FIG. 3, the third receptacle spring portion 35 includes a second receptacle contact connection portion 50 that is connected to the receptacle contact portion 12. The second receptacle contact connection portion 50 is a member having an L-shape (a mirror image of the letter L) when viewed in the Y-axis direction, has one end (an end portion closer to the +Z direction) connected to the receptacle contact portion 12, extends from the connected portion in the −Z direction, and is bent in the +X direction.

The third receptacle spring portion 35 and the fourth receptacle spring portion 36 have the receptacle slit 52 that extends in the direction intersecting the insertion and removal direction. As illustrated in FIG. 3, the third receptacle spring portion 35 is divided by the receptacle slit 52 into the above-described second receptacle contact connection portion 50 and a seventh extension portion 51. The fourth receptacle spring portion 36 includes a fifth extension portion 53, a sixth extension portion 54, and a third return portion 55 due to the receptacle slit 52.

As illustrated in FIG. 3, the fifth extension portion 53 extends in the Y-axis direction. The fifth extension portion 53 has one end (an end portion closer to the +Y direction) connected to an end portion of the second receptacle contact connection portion 50 closer to the +X direction. The sixth extension portion 54 is disposed closer to the receptacle substrate connection portion 11 than the fifth extension portion 53. The sixth extension portion 54 extends in parallel with the fifth extension portion 53, that is, in the Y-axis direction. The third return portion 55 connects, in the insertion and removal direction, that is, in the Z-axis direction, the other end (an end portion closer to the −Y direction) of the fifth extension portion 53 to one end (an end portion closer to the −Y direction) of the sixth extension portion 54 that faces the other end of the fifth extension portion 53.

Furthermore, in the third receptacle spring portion 35, the seventh extension portion 51 is located closer to the receptacle substrate connection portion 11 than the second receptacle contact connection portion 50, and extends in the X-axis direction that intersects the insertion and removal direction. The seventh extension portion 51 has one end (an end portion closer to the +X direction) connected to the other end (an end portion closer to the +Y direction) of the sixth extension portion 54. The seventh extension portion 51 is connected to the receptacle substrate connection portion 11.

As described above, the second receptacle elastic portion 14 is configured by sequentially connecting, from the receptacle contact portion 12, the second receptacle contact connection portion 50, the fifth extension portion 53, the third return portion 55, the sixth extension portion 54, and the seventh extension portion 51, and is ultimately connected to the receptacle substrate connection portion 11.

As illustrated in FIGS. 1 and 3, the first receptacle elastic portion 13 and the second receptacle elastic portion 14 are disposed in a point symmetry with the receptacle contact portion 12 at the center when viewed in the insertion and removal direction (the Z-axis direction).

FIG. 5 illustrates a schematic view of a simplified structure of the first receptacle elastic portion 13 and the second receptacle elastic portion 14. FIG. 5 illustrates the first receptacle spring portion 33 and the second receptacle spring portion 34 included in the first receptacle elastic portion 13 as linear members, and illustrates the third receptacle spring portion 35 and the fourth receptacle spring portion 36 included in the second receptacle elastic portion 14 as linear members. The same applies to the receptacle substrate connection portion 11.

The position of the receptacle substrate connection portion 11 connected to the first substrate 3 is fixed. However, the first receptacle elastic portion 13 and the second receptacle elastic portion 14, which connect the receptacle substrate connection portion 11 and the receptacle contact portion 12, are elastic, and thus can return the receptacle contact portion 12 to its original position even when the receptacle contact portion 12 receives an external force.

More specifically, as illustrated in FIG. 5, the first receptacle elastic portion 13 allows displacement, relative to the receptacle substrate connection portion 11 of which the position is fixed, of positions P11, P12, P13, P14, P15, and P16 between the receptacle substrate connection portion 11 and the receptacle contact portion 12 in the X-axis, Y-axis, and Z-axis directions, and allows torsional rotation of each of the portions (the third extension portion 41, the second extension portion 44, the first return portion 45, the first extension portion 43, and the first receptacle contact connection portion 40) around its own axis in an extending direction. As illustrated in FIG. 5, the second receptacle elastic portion 14 allows displacement, relative to the receptacle substrate connection portion 11 of which the position is fixed, of positions P21, P22, P23, P24, P25, and P26 between the receptacle substrate connection portion 11 and the receptacle contact portion 12 in the X-axis, Y-axis, and Z-axis directions, and allows torsional rotation of each of the portions (the seventh extension portion 51, the sixth extension portion 54, the third return portion 55, the fifth extension portion 53, and the second receptacle contact connection portion 50) around its own axis in an extending direction. Displacement of the positions P11 to P16 and displacement of the positions P21 to P26 as described above allow the receptacle contact portion 12 to move in the X-axis, Y-axis, and Z-axis directions and rotate in a rotational direction about each axis.

However, since the frame portion 30 of the receptacle contact portion 12 has a rectangular frame shape, displacement of the positions P16 and P26 merely changes the X-coordinate, Y-coordinate, and Z-coordinate and the postures around the X-axis, Y-axis, and Z-axis directions, and deformation of the first receptacle elastic portion 13 and the second receptacle elastic portion 14 does not change the relative positional relationship between the first contact piece 31 and the second contact piece 32. In other words, a force applied to the first contact piece 31 and the second contact piece 32 due to insertion or removal of the plug terminal 2 is transmitted to the first receptacle elastic portion 13 and the second receptacle elastic portion 14 via the receptacle contact portion 12, and the resulting deformation of the first receptacle elastic portion 13 and the second receptacle elastic portion 14 suppresses deformation of the frame portion 30.

### Plug Terminal

First, the plug terminal 2 is described. As illustrated in FIG. 6, the plug terminal 2 is mounted on a second substrate 4. In FIG. 6, the second substrate 4 is illustrated by dotted lines. In FIG. 6, the X and Y axes are defined as coordinate axes along a main surface of the second substrate 4. The Z axis is defined as a coordinate axis extending in a normal direction of the main surface of the second substrate 4.

The plug terminal 2 is formed of a conductive material such as metal. The plug terminal 2 is formed in a shape illustrated in FIG. 6 by performing the punching processing on an elastic metal plate and then performing the bending processing thereon. The metal plate has a plate thickness of, for example, about 0.5 mm, which is not limited thereto.

As illustrated in FIG. 6, the plug terminal 2 includes plug substrate connection portions 21, the plug contact portion 22, a first plug elastic portion 23, a second plug elastic portion 24, and a plug contact connection portion 25.

The plug substrate connection portions 21 are connected to the second substrate 4. The plug terminal 2 includes a pair of the receptacle substrate connection portions 21. The second substrate 4 has rectangular through holes, and the plug substrate connection portions 21 are inserted into the through holes and soldered. In this way, the plug substrate connection portions 21 are mounted on the main surface of the second substrate 4. In FIG. 6, the main surface of the second substrate 4 is a surface facing the −Z direction. The plug terminal 2 includes plug positioning portions 21a around the plug substrate connection portion 21 to prevent the plug terminal 2 from being mounted obliquely to the second substrate 4. On the main surface of the second substrate 4, electronic components are mounted and an electric circuit including these electronic components is constructed. An electrode is connected to the electric circuit, and the plug substrate connection portions 21 inserted in the through holes are connected to the electrode.

The plug contact portion 22 comes in contact with the receptacle contact portion 12 of the receptacle terminal 1A described later. As illustrated in FIG. 6, the plug contact portion 22 is a protruding contact that protrudes in the −Z direction. In the present embodiment, the Z-axis direction is the insertion and removal direction in which the plug contact portion 22 is inserted into or removed from the receptacle contact portion 12 of the receptacle terminal 1A. The size of the plug contact portion 22, for example, the length in the Z-axis direction is determined in consideration of a permissible position deviation amount (a floating amount) between the receptacle contact portion 12 of the receptacle terminal 1A and the plug contact portion 22. The permissible position deviation amount is, for example, 1.0 mm, which is not limited thereto. The length of the plug contact portion 22 in the Z-axis direction is, for example, 4.0 mm, which is not limited thereto.

The first plug elastic portion 23 connects one plug substrate connection portion 21 of the pair of plug substrate connection portions 21 to the plug contact portion 22. The second plug elastic portion 24 connects the other plug substrate connection portion 21 of the pair of the plug substrate connection portions 21, which is not connected to the first plug elastic portion 23, to the plug contact portion 22.

The plug contact connection portion 25 connects the first plug elastic portion 23 and the second plug elastic portion 24 to the plug contact portion 22. As illustrated in FIG. 6, the plug contact connection portion 25 includes a plug slit 56 that extends in the X-axis direction from an end portion closer to the +Z direction. The plug slit 56 extends to the plug contact portion 22. This plug slit 56 divides the plug contact connection portion 25 into a portion connected to the first plug elastic portion 23 and a portion connected to the second plug elastic portion 24. The plug slit 56 allows the first plug elastic portion 23 and the second plug elastic portion 24 to separately deform and change the position of the plug contact portion 22 in the X-axis, Y-axis, and Z-axis directions and the posture of the plug contact portion 22 around the X, Y, and Z axes with respect to the plug substrate connection portions 21.

### Mating Operation

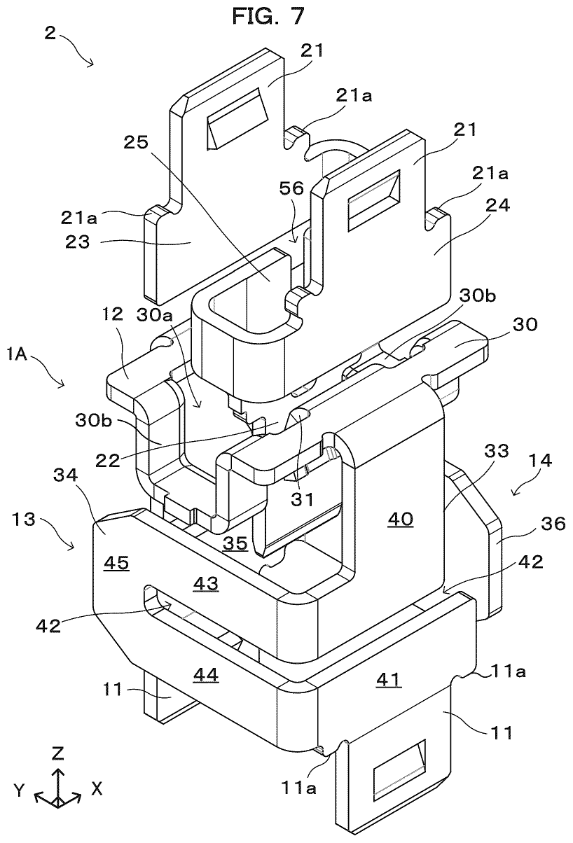

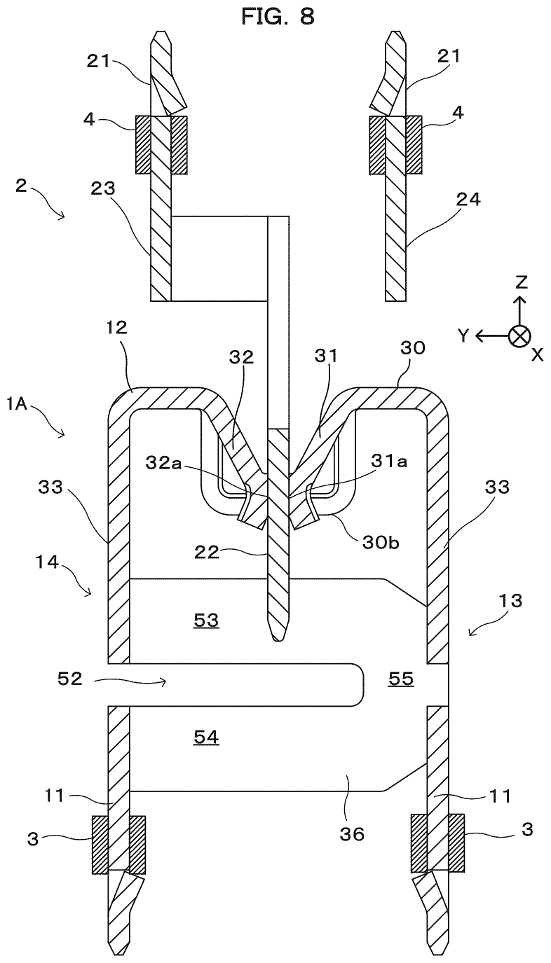

Next, a mating operation between the receptacle terminal 1A and the plug terminal 2 according to Embodiment 1 is described. As illustrated in FIGS. 7 and 8, the receptacle terminal 1A and the plug terminal 2 are connected to each other by inserting the protruding plug contact portion 22 of the plug terminal 2 into the recessed receptacle contact portion 12 of the receptacle terminal 1A. In this way, the electric circuit of the first substrate 3 and the electric circuit of the second substrate 4 are electrically connected with each other via the receptacle terminal 1A and the plug terminal 2, which allows transmission of signals or grounding between the first substrate 3 and the second substrate 4.

Since each of the receptacle terminal 1A and the plug terminal 2 is deformable due to its elasticity, even when there is some deviation in the relative displacement between the receptacle contact portion 12 and the plug contact portion 22, the receptacle contact portion 12 and the plug contact portion 22 can mate with each other.

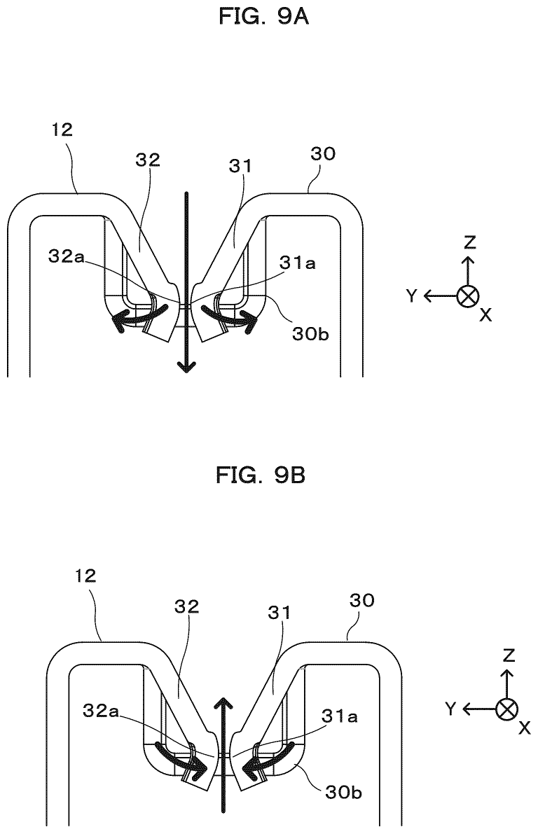

As illustrated in FIG. 9A, when the plug contact portion 22 (see FIG. 6) is inserted between the first contact piece 31 and the second contact piece 32 of the receptacle contact portion 12, a frictional force generated when the plug contact portion 22 moves in the-Z direction causes the first contact piece 31 and the second contact piece 32 to receive a force in a direction of an arrow, that is, in a direction in which the gap between the first contact piece 31 and the second contact piece 32 increases, which allows the plug contact portion 22 to be inserted between the first contact piece 31 and the second contact piece 32 without using a large amount of force.

As illustrated in FIG. 9B, when the plug contact portion 22 inserted in the receptacle contact portion 12 is removed, a frictional force generated when the plug contact portion 22 moves in the +Z direction causes the first contact piece 31 and the second contact piece 32 to receive a force in a direction of an arrow, that is, in a direction in which the gap between the first contact piece 31 and the second contact piece 32 decreases, which prevents the plug contact portion 22 from being easily removed from between the first contact piece 31 and the second contact piece 32.

As illustrated in FIG. 3, the frame portion 30 is formed of the continuous member with no cuts along the edge of the insertion opening 30a. In this configuration, the force applied from the plug contact portion 22 when the plug contact portion 22 is inserted between the first contact piece 31 and the second contact piece 32 prevents the frame portion 30 from deforming, and achieves unchanged relative positional relationship between a fixed end of the first contact piece 31 and a fixed end of the second contact piece 32. Therefore, the force in the direction in which the gap between the first contact piece 31 and the second contact piece 32 increases as illustrated in FIG. 9A and the force in the direction in which the gap between the first contact piece 31 and the second contact piece 32 decreases as illustrated in FIG. 9B can be appropriately generated.

In a configuration in which an extending direction of the first contact piece 31 and the second contact piece 32 is opposite to that in the receptacle terminal 1A according to the present embodiment, that is, the +Z direction, a force in the direction in which the gap between the first contact piece 31 and the second contact piece 32 decreases is applied thereto when the plug contact portion 22 is inserted, and insertion of the plug contact portion 22 thus becomes more difficult. Furthermore, when the plug contact portion 22 is removed, a force in the direction in which the gap between the first contact piece 31 and the second contact piece 32 increases is applied thereto, and removal of the plug contact portion 22 thus becomes easier. Therefore, in the receptacle terminal 1A, the extending direction of the first contact piece 31 and the second contact piece 32 is set to the −Z direction.

The receptacle terminal 1A and the plug terminal 2 are subjected to Ag plating, Sn reflow plating, or the like, and the effects as illustrated in FIGS. 9A and 9B can be obtained even when any type of plating is applied. The same applies even when a lubricant is further applied on the plating.

### Embodiment 2

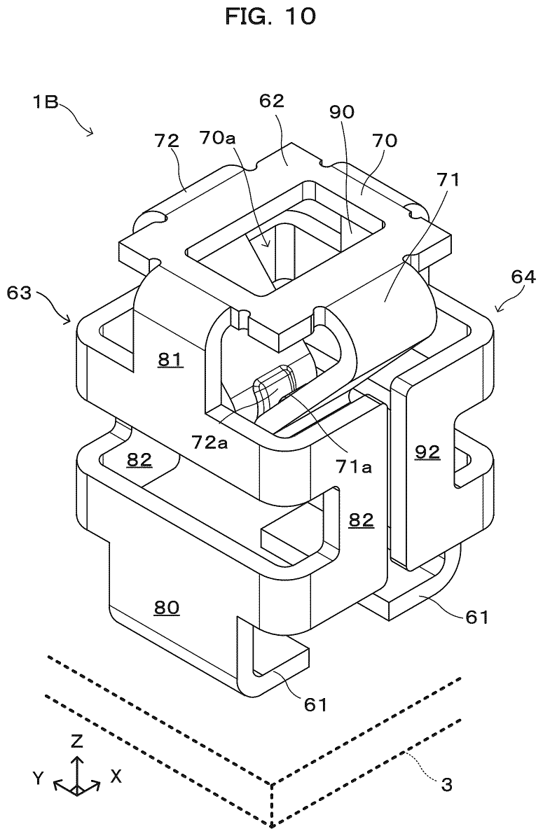

Next, Embodiment 2 of the present disclosure is described. In the present embodiment, a receptacle terminal 1B illustrated in FIG. 10 is used instead of the receptacle terminal 1A. The receptacle terminal 1B is the same as the receptacle terminal 1A in terms of material, being mounted on the first substrate 3, and mating with the plug terminal 2.

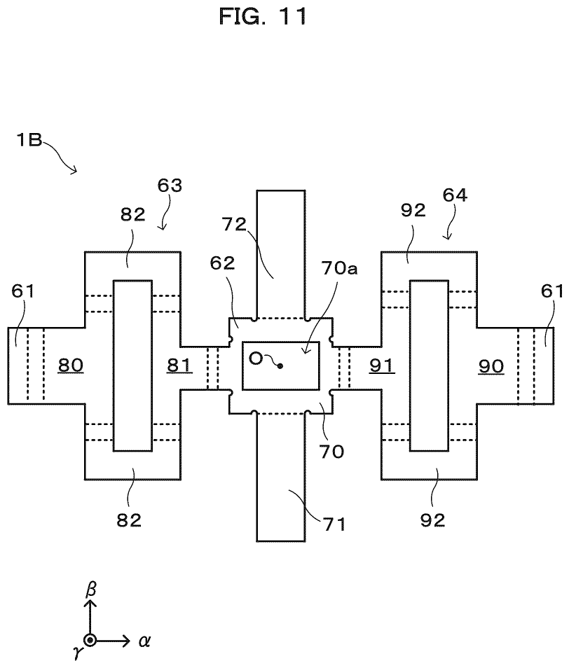

The receptacle terminal 1B is formed by, for example, performing the punching processing and the bending processing on a metal plate. Specifically, the receptacle terminal 1B is formed by performing the punching processing on an elastic metal plate to be processed into a shape illustrated in FIG. 11. Coordinate axes along an in-plane direction of the metal plate are defined as the α and β axes, and a coordinate axis along a thickness direction of the metal plate is defined as the γ axis. As illustrated in FIG. 11, this metal plate has a point-symmetric shape with respect to the central point O. After the punching processing, the metal plate is bent along broken lines by the bending processing to be processed into a shape illustrated in FIG. 10. The metal plate has a plate thickness of, for example, about 0.5 mm, which is not limited thereto.

Returning to FIG. 10, the receptacle terminal 1B includes receptacle substrate connection portions 61, a receptacle contact portion 62, a first receptacle elastic portion 63, and a second receptacle elastic portion 64.

The receptacle substrate connection portions 61 are connected to the first substrate 3. The receptacle terminal 1B includes a pair of the receptacle substrate connection portions 61. The receptacle substrate connection portions 61 are soldered to a non-illustrated electrode formed on the main surface of the first substrate 3.

The receptacle contact portion 62 comes in contact with the plug contact portion 22 of the plug terminal 2 (see FIG. 6) inserted in the insertion and removal direction that intersects the main surface of the first substrate 3. As illustrated in FIG. 10, the receptacle contact portion 62 is a recessed contact, and comes in contact with the protruding plug contact portion 22 of the plug terminal 2 inserted in the insertion and removal direction.

As illustrated in FIG. 10, the receptacle contact portion 62 includes a frame portion 70, a first contact piece 71, and a second contact piece 72. The frame portion 70 is formed of a single plate material as illustrated in FIG. 10. In the present embodiment, the frame portion 70 before the bending processing is performed has a rectangular outer shape. The frame portion 70 has an insertion opening 70a through which the plug contact portion 22 of the plug terminal 2 (see FIG. 6) is inserted and removed. The insertion opening 70a is a through hole passing through the plate material in a thickness direction thereof. The frame portion 70 is formed of a continuous member with no cuts along an edge of the insertion opening 70a.

As illustrated in FIG. 10, the first contact piece 71 and the second contact piece 72 are a pair of elastic members disposed facing each other along the Y-axis direction. Each of the first contact piece 71 and the second contact piece 72 has one end connected to the frame portion 70, and is a cantilever extending from the one end connected to the frame portion 70 in the insertion direction of the plug contact portion 22 included in the Z-axis direction that is the insertion and removal direction of the plug contact portion 22 with respect to the insertion opening 70a. In the present embodiment, the first contact piece 71 and the second contact piece 72 are connected to outer edges of the frame portion 70. The first contact piece 71 and the second contact piece 72 hold the plug contact portion 22 of the plug terminal 2 inserted therebetween.

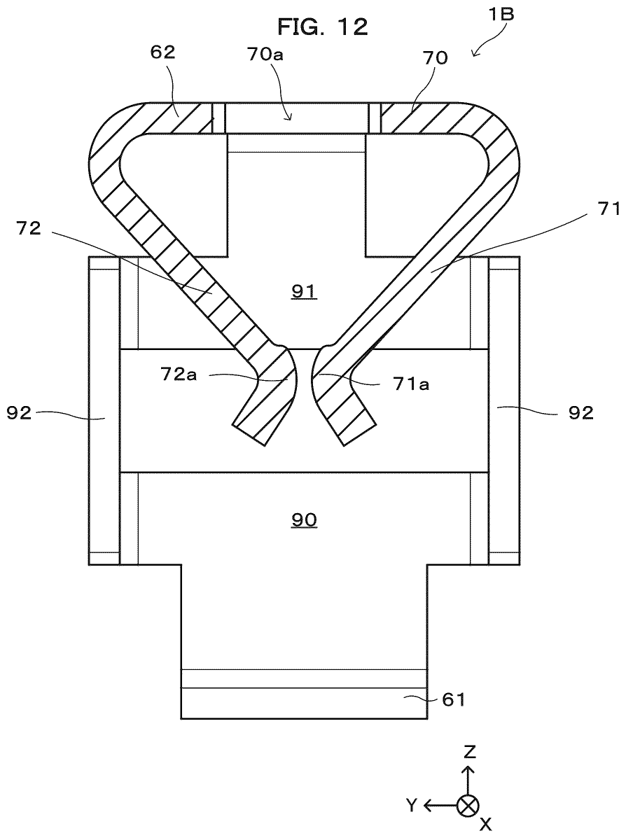

As illustrated in FIGS. 10 and 12, the first contact piece 71 includes a stamped contact 71a between the one end, which is connected to the frame portion 70, and the other end. The second contact piece 72 includes a stamped contact 72a between the one end, which is connected to the frame portion 70, and the other end. The first contact piece 71 comes in contact with the plug contact portion 22 at the stamped contact 71a, and the second contact piece 72 comes in contact with the plug contact portion 22 at the stamped contact 72a. As illustrated in FIG. 12, in the first contact piece 71 and the second contact piece 72, each of the stamped contacts 71a and 72a protrudes in a direction approaching the other. The first contact piece 71 and the second contact piece 72 hold the plug contact portion 22 between the stamped contacts 71 a and 72a. The first contact piece 71 and the second contact piece 72 differ from the first contact piece 31 and the second contact piece 32 according to Embodiment 1 described above in a term of being connected to the outer edges of the frame portion 70 instead of an edge of the insertion opening 70a.

As illustrated in FIG. 10, the frame portion 70 of the receptacle contact portion 62 is connected to the first receptacle elastic portion 63 and the second receptacle elastic portion 64. The frame portion 70 is connected to the first receptacle elastic portion 63 at the center of the outer edge closer to the −X direction included in the two outer edges along the X direction, and is connected to the second receptacle elastic portion 64 at the center of the outer edge closer to the +X direction included in the above-described two outer edges.

### First Receptacle Elastic Portion

The first receptacle elastic portion 63 connects one receptacle substrate connection portion 61 of the pair of receptacle substrate connection portions 61 to the receptacle contact portion 62. The first receptacle elastic portion 63 includes a connection portion 80 that is connected to the receptacle substrate connection portion 61, a connection portion 81 that is connected to the receptacle contact portion 62, and a rectangular frame portion 82 that is inserted between the connection portions 80 and 81. Both end portions of the rectangular frame portion 82 in the β-axis direction (see FIG. 11) are bent at 90 degrees to form the first receptacle elastic portion 63 illustrated in FIG. 10. The second receptacle elastic portion 64 includes a connection portion 90 that is connected to the receptacle substrate connection portion 61, a connection portion 91 that is connected to the receptacle contact portion 62, and a rectangular frame portion 92 that is inserted between the connection portions 90 and 91. Both end portions of the rectangular frame portion 92 in the β-axis direction (see FIG. 11) are bent at 90 degrees to form the second receptacle elastic portion 64 illustrated in FIG. 10.

### Mating Operation

Next, a mating operation between the receptacle terminal 1B and the plug terminal 2 according to Embodiment 1 is described. As illustrated in FIG. 10, the receptacle terminal 1B and the plug terminal 2 are connected to each other by inserting the protruding plug contact portion 22 of the plug terminal 2 (see FIG. 6) into the recessed receptacle contact portion 62 of the receptacle terminal 1B. Since each of the receptacle terminal 1B and the plug terminal 2 is deformable due to its elasticity, even when there is deviation in the relative displacement between the receptacle contact portion 62 and the plug contact portion 22, the receptacle contact portion 62 and the plug contact portion 22 can mate with each other.

As with the receptacle terminal 1A, in the receptacle terminal 1B, when the plug contact portion 22 is inserted between the first contact piece 71 and the second contact piece 72 of the receptacle contact portion 62, a frictional force generated when the plug contact portion 22 moves in the −Z direction causes the first contact piece 71 and the second contact piece 72 to receive a force in a direction in which a gap between the first contact piece 71 and the second contact piece 72 increases, which allows the plug contact portion 22 to be inserted between the first contact piece 71 and the second contact piece 72 without using a large amount of force.

When the plug contact portion 22 is removed from between the first contact piece 71 and the second contact piece 72 of the receptacle contact portion 62, a frictional force generated by this removal causes the first contact piece 71 and the second contact piece 72 to receive a force in a direction in which the gap therebetween decreases, which prevents the plug contact portion 22 from being removed from between the first contact piece 71 and the second contact piece 72.

As with the receptacle terminal 1A, in the receptacle terminal 1B according to the above-described embodiment, the force applied from the plug terminal 2 is absorbed by deformation of the first receptacle elastic portion 63 and the second receptacle elastic portion 64. The first receptacle elastic portion 63 and the second receptacle elastic portion 64 have symmetric shapes in the X-axis and Y-axis directions with respect to the center thereof. Therefore, when the same amount of force is applied to the first receptacle elastic portion 63 and the second receptacle elastic portion 64, the deformation amounts of the first receptacle elastic portion 63 and the second receptacle elastic portion 64 are the same in the +X and −X directions and the same in the +Y and −Y directions.

### Embodiment 3

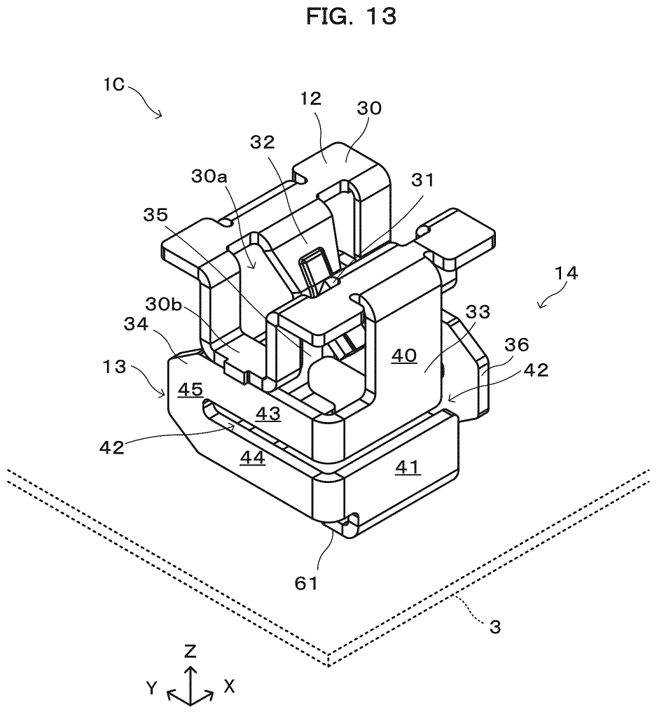

Next, Embodiment 3 of the present disclosure is described. As illustrated in FIG. 13, a receptacle terminal 1C according to the present embodiment differs from the receptacle terminal 1A according to Embodiment 1 described above in a term of including the receptacle substrate connection portion 61 instead of the receptacle substrate connection portion 11.

As with the receptacle terminal 1A, the receptacle terminal 1C includes the first receptacle elastic portion 13 and the second receptacle elastic portion 14. The first receptacle elastic portion 13 includes the first receptacle spring portion 33 that has one end connected to the frame portion 30 and extends in the X-axis direction (a first direction) intersecting the insertion and removal direction of the plug terminal 2, and the second receptacle spring portion 34 that has one end connected to the other end of the first receptacle spring portion 33, has the other end connected to the receptacle substrate connection portion 61, and extends in a second direction (the Y-axis direction) intersecting the insertion and removal direction and the X-axis direction. The second receptacle elastic portion 14 includes the first receptacle spring portion 33 that has one end connected to the frame portion 30 and extends in the X-axis direction (the first direction) intersecting the insertion and removal direction of the plug terminal 2, and the second receptacle spring portion 34 that has one end connected to the other end of the first receptacle spring portion 33, has the other end connected to the receptacle substrate connection portion 61, and extends in the second direction (the Y-axis direction) intersecting the insertion and removal direction and the X-axis direction.

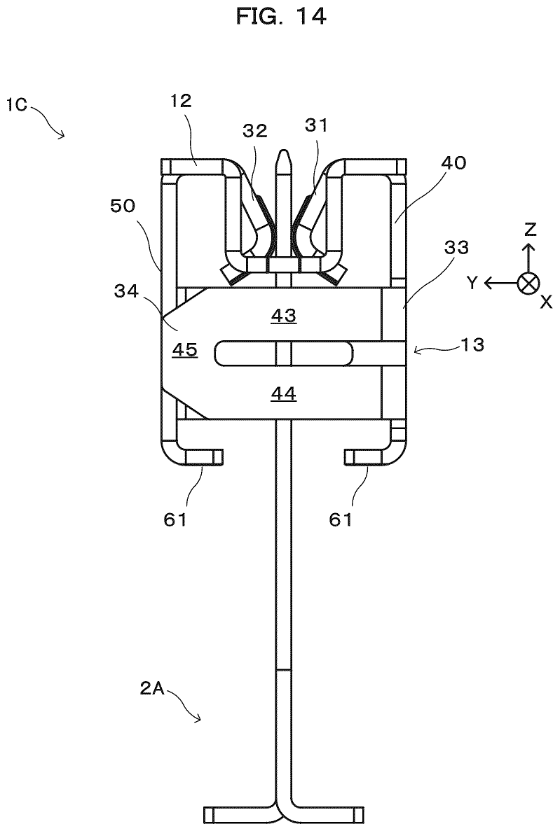

As with the receptacle terminals 1A and 1B, the receptacle terminal 1C may be configured to mate with the plug terminal 2 inserted from the +Z side in the −Z direction, or may be configured to mate with the plug terminal 2A inserted in the opposite direction as illustrated in FIG. 14. The same applies to the receptacle terminals 1A and 1B.

The receptacle terminal 1C according to the present embodiment includes the first receptacle elastic portion 13 and the second receptacle elastic portion 14 that connect the receptacle substrate connection portion 61 with the receptacle contact portion 12. This allows the relative position of the receptacle contact portion 12 with respect to the receptacle substrate connection portion 61 to be deviated in the X-axis and Y-axis directions that intersect the insertion and removal direction of the plug terminals 2 and 2A, the Z-axis direction that is parallel to the insertion and removal direction, and the rotational direction of each of the X, Y, Z axes, and thus allows improvement of followability to the plug terminals 2 and 2A.

As described above, the receptacle terminal 1C according to the present embodiment allows the receptacle contact portion 12 to float in the Z-axis direction (an insertion direction of a plug), and thus allows the receptacle contact portion 12 to follow the insertion direction of the plug terminals 2 and 2A, which prevents abrasion at the contacts thereof and improves resistance to micro-sliding wear.

The frame portion 30 and the insertion opening 30a of the receptacle terminal 1A and the frame portion 70 and the insertion opening 70a of the receptacle terminal 1B are not limited to have a rectangular shape. For example, a circular shape, an elliptical shape, and other polygonal shapes may be employed. Although there is no limitation on the shapes of the members between the receptacle substrate connection portions 11 and 61 and the receptacle contact portions 12 and 62, the members are preferably deformable by the force applied from the plug terminal 2.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2023-65964, filed on Apr. 13, 2023, the entire disclosure of which is incorporated by reference herein.

### REFERENCE SIGNS LIST

1A, 1B, 1C Receptacle terminal (terminal)
2, 2A Plug terminal (mating terminal)
3 First substrate
4 Second substrate
11 Receptacle substrate connection portion
11a Receptacle positioning portion
12 Receptacle contact portion (frame portion)
13 First receptacle elastic portion (elastic portion)
14 Second receptacle elastic portion (elastic portion)
21 Plug substrate connection portion
21a Plug positioning portion
22 Plug contact portion (mating contact piece)
23 First plug elastic portion
24 Second plug elastic portion
25 Plug contact connection portion
30 Frame portion
30a Insertion opening
30b Regulation portion
31 First contact piece
31a Stamped contact
32 Second contact piece
32a Stamped contact
33 First receptacle spring portion (first spring portion)
34 Second receptacle spring portion (second spring portion)
35 Third receptacle spring portion
36 Fourth receptacle spring portion
40 First receptacle contact connection portion
41 Third extension portion
42 Receptacle slit
43 First extension portion
44 Second extension portion
45 First return portion
50 Second receptacle contact connection portion
51 Seventh extension portion
52 Receptacle slit
53 Fifth extension portion
54 Sixth extension portion
55 Third return portion
56 Plug slit
61 Receptacle substrate connection portion
62 Receptacle contact portion
63 First receptacle elastic portion
64 Second receptacle elastic portion
70 Frame portion
70a Insertion opening
71 First contact piece
71a Stamped contact
72 Second contact piece
72a Stamped contact
80, 81 Connection portion
82 Rectangular frame portion
90, 91 Connection portion
92 Rectangular frame portion

1. A terminal formed of a conductive material and configured to mate with a mating terminal, the terminal comprising:
a frame portion having an insertion opening through which a mating contact piece of the mating terminal is inserted and removed; and
contact pieces each having one end connected to the frame portion and extending from the one end in an insertion direction of the mating contact piece included in an insertion and removal direction of the mating contact piece with respect to the insertion opening, each of the contact pieces being configured to come into contact with the mating contact piece at a contact between the one end and the other end, wherein
the frame portion is formed of a continuous member with no cut along an edge of the insertion opening.

2. The terminal according to claim 1, wherein the contact pieces are a pair of elastic members to hold the mating contact piece between the contacts.

3. The terminal according to claim 2, wherein
the pair of elastic members has the contacts each protruding in a direction approaching the other.

4. The terminal according to claim 1, wherein
each of the contact pieces has a distance from the one end to the contact longer than a distance from the contact to the other end.

5. The terminal according to claim 1, wherein
the frame portion is formed of a single plate material, and
the insertion opening is a through hole passing through the plate material in a thickness direction thereof.

6. The terminal according to claim 1, wherein
the one end is formed at the edge of the insertion opening.

7. The terminal according to claim 1, wherein
the one end is formed at an outer edge of the frame portion.

8. The terminal according to claim 1, further comprising:
a substrate connection portion connected to a substrate; and
a pair of elastic portions to connect the substrate connection portion and the frame portion, wherein
each elastic portion of the pair of elastic portions includes
a first spring portion having one end connected to the frame portion, the first spring portion extending in a first direction intersecting the insertion and removal direction of the mating terminal, and
a second spring portion having one end connected to the other end of the first spring portion and the other end connected to the substrate connection portion, the second spring portion extending in a second direction intersecting the insertion and removal direction and the first direction.
